(19) United States
(12) Patent Application Publication
(10) Pub. No.: US 2026/0110187 A1
(43) Pub. Date: Apr. 23, 2026

(54) DAMPING DEVICE, DAMPING SYSTEM, TOWER SYSTEM AND METHOD

(71) Applicant: Nordex Energy SE & Co. KG, Hamburg (DE)

(72) Inventors: Lars Estermann, Hamburg (DE); Shiraj Baral, Hamburg (DE)

(21) Appl. No.: 19/364,757

(22) Filed: Oct. 21, 2025

Related U.S. Application Data
(60) Provisional application No. 63/709,846, filed on Oct. 21, 2024.

(51) Int. Cl. E04H 12/20; F03D 13/20

(52) U.S. Cl. CPC E04H 12/20; F03D 13/201

(57) ABSTRACT

In an embodiment a damping device includes a first rope configured to be connected to a tower and a first frame configured to be supported in a stationary manner on ground, to be coupled to the first rope, and to keep the first rope under tension.

### CROSS-REFERENCE TO RELATED APPLICATIONS

This application claims the benefit of U.S. Provisional Application No. 63/709,846, filed on Oct. 21, 2024, which application is hereby incorporated herein by reference.

### TECHNICAL FIELD

The disclosure relates to a damping device for a tower for a wind turbine, in particular for damping tower vibration during erection of the tower. The disclosure further relates to a damping system, in particular to a damping system with two or more damping devices as disclosed herein. The disclosure further relates to a tower system, in particular to a tower system with a damping device as disclosed herein. The disclosure further relates to a method for determining a site-specific configuration for a damping device for a tower of a wind turbine, in particular for a damping device as disclosed herein.

### BACKGROUND

A wind turbine may include a rotor that includes a rotatable rotor assembly having multiple rotor blades. The rotor blades transform wind energy into a drive torque that drives the generator of the wind turbine via a drive train. The rotor is arranged on top of a tower of the wind turbine.

It is desirable to provide a damping device for a tower for a wind turbine, a damping system for a tower for a wind turbine, a tower system for a wind turbine, and method for determining a site-specific configuration for a damping device for a tower of a wind turbine, each of which provides a reliable operation.

Prior applications address positioning a damping device with one single rope per direction spaced apart from the tower at a radial distance of 25 to 240 meters, for example European Patent EP 3 511 566 B1 the disclosure of which is incorporated by reference herein in its entirety for all purposes.

### SUMMARY

Embodiments of the disclosure provide benefits to applying a shorter distance and/or two or more ropes per direction.

Embodiments of the disclosure provide a damping device for a wind turbine. Embodiments of the disclosure provide a damping system for a tower for a wind turbine. Embodiments of the disclosure provide a tower system for a wind turbine. Embodiments of the disclosure provide a method for determining a site-specific configuration for a damping device for a tower of a wind turbine.

The damping device comprises a first rope. The first rope is configured to be connected to the tower for the wind turbine. In particular, the first rope is configured to be connected to the tower during erection of the tower and the wind turbine. The first rope may be connected either at the upper-mid section or at the top tower section. According to further examples, the first rope may be connected to any section of the tower, preferably the penultimate mid-section, the upper-mid section or the top tower section. When the wind turbine is ready for operation, in particular, when the nacelle is arranged on the tower, the first rope is removed again.

The damping device comprises a first frame. The first frame is configured to be supported in a stationary manner onto the ground. The first frame is configured to be coupled to the first rope and to keep the first rope under tension. The first frame is configured to keep the first rope under tension between the rope and the first frame. The first frame may be securely anchored to the ground to transmit sufficient forces to tension the first rope such that the tower may be stabilized by the tensioned first rope and vibrations that could damage the tower are reduced or avoided.

Wind turbines are exposed to time-varying loads in winds. Wind turbines are designed in accordance with international regulations so that they can withstand different wind speeds. When designing wind turbine towers, vibrations caused by air vortices alternating sideways along the height of the tower must also be taken into account. The vibrations occur transversely to the direction of airflow within a specific wind speed range. These vortex-induced transverse vibrations are generally relevant in terms of damage to components due to fatigue.

Reducing vibrations in the tower of a wind turbine is particularly important when the wind turbine is still in the installation phase and the vibrations cannot yet be counteracted with active control measures, such as azimuth and/or rotor blade adjustment.

The damping device with the first rope and the first frame is configured to damping and reducing vibrations in the tower during the installation of the wind turbine. The damping device may be called Frictional Guy Rope (FGR). The damping device causes the tower not entering resonance due to Vortex effect covering any wind direction, in particular during erection of the wind turbine.

A first end of the first rope of the FGR, in particular a spiral cable, is attached to the tower.

To maintain tension in the first rope, a second end (lower end) of the first rope is suspended by a ballast mass located inside the first frame. The first rope is in stretch contact with a beam of the first frame producing friction and/or displacement. The beam is for example a wood beam. Other materials for the beam are possible.

For example, the wire rope may be guided or is guided successively over a first and a second beam, wherein the beams for example each at least partially have a convex surface made of a material which, in conjunction with a round-strand steel rope in the dry state, results in a sliding friction coefficient of greater than 0.3, for example greater than 0.4.

According to some embodiments, the first frame is configured to be anchored to the ground. In the context of this disclosure, anchored means in particular that the frame is set up on the ground and weighted down to ensure stability. Ground anchors or similar devices that penetrate the ground are not necessarily required. Fixing the frame to the ground using weights without additional anchoring elements that penetrate the ground is sufficient to secure the frame to the ground. Anchoring can therefore also mean placing the first frame on the ground so that relative movement to the ground is avoided. For example, the first frame is configured to be supported on the ground. For example, the first frame is configured to be held firmly in place by weights.

According to some embodiments, the first frame is configured to be supported in a stationary manner on the ground, such that a distance from the tower to the first frame is 24 meters or less. For example, the distance is 20 meters or less. For example, the distance is 15 meters or less. For example, the distance is 14 meters or less. For example, the distance is 13 meters or less. For example, the distance is 12 meters or less. For example, the distance is 11 meters or less. For example, the distance is 1 meter or more. For example, the distance is 5 meter or more. For example, the distance is 1 meter or more. For example, the distance is 8 meter or more. For example, the distance is in a range of between 11 and 21 meters. For example, the distance is in a range of between 8 and 12 meters. For example, the distance is in a range of between 8 and 21 meters. For example, the distance is in a range of between 11 and 18 meters. For example, the distance is one of 10 meters, 11 meters, 12 meters, 13 meters, 14 meters, and 15 meters.

For example, the distance is the distance of the frame of a plurality of frames which is located closest to the tower. For example, the distance is the distance of the frame of a plurality of frames which is furthest away from the tower. For example, the distance specified above is applicable to all frames of the tower.

For example, the distance is the radial distance between the axis of the first (upper) beam of the frame to the tower shell. For example, the distance is in a range of between 5 and 24 meters. For example, the distance r is in a range of between 8 and 21 meters. For example, the distance r is in a range of between 11 and 18 meters. For example, the distance r is one of 10 meters, 11 meters, 12 meters, 13 meters, 14 meters, and 15 meters. For example, the frame is arranged such that a distance from the axis of the first (upper) beam to the central axis of the tower is 24 meters or less. For example, the distance is between the tower shell and the center of the frame.

There are construction sites with little space around the tower for arranging the frame of the damping device, for example due to small crane pads or environmental constraints. The damping device disclosed herein enable a reliable damping even in such construction sites with little space around the tower.

According to some embodiments, the damping device comprises a second rope. The second rope is configured to be connected to a tower for a wind turbine. The damping device comprises a second frame. The second frame is configured to be supported in a stationary manner on the ground and to be coupled to the second rope and to keep the second rope under tension.

According to some embodiments, the first rope and the second rope are of the same kind. According to some embodiments, the first frame and the second frame are of the same kind.

The first rope and the second rope are arranged or arrangeable such that they support the frame in one common direction. Thus, the first rope and the second rope are arranged or arrangeable such that they support the frame in one common circular section.

The applicant has surprisingly discovered that multiple ropes per one common direction are beneficial for a reliable damping. The applicant has surprisingly discovered that, for example, multiple ropes per one common direction enable the distances mentioned above. Thus, even with the distances mentioned above sufficient damping and prevention of vibrations is achieved with the device disclosed herein. Multiple ropes per direction are used to achieve sufficient damping forces. Sufficient damping can be achieved even where space is limited. Multiple ropes per one common direction can also mean that a first plurality of ropes is arranged in a first common region, which for example corresponds to the first common circular sector, and a second plurality of ropes is arranged in a second common region, which for example corresponds to the second common circular sector, wherein the first and the second region are distinct to each other and arranged spaced apart from each other. These statements apply in particular also to a damping device with multiple frames per one common circular sector.

For example, the damping device with multiple ropes and multiple frames per common circular sector enables the desired damping effect for the tower with lighter and/or smaller frames than if only a single frame per sector were provided. For example, this makes it possible to achieve simpler logistics and/or greater cost efficiency.

According to some embodiments, two or more ropes per one common circular section for example means the ropes are aligned congruent in a view from above and/or with a small angle, for example between 0° and 5° or 10°, or between 0° and 30°, between them when viewed from above.

The term “one common circular sector” can also be referred to as “one common direction”.

According to some embodiments, the first and the second ropes are configured to be arranged or are arranged in a common circular sector with a central angle in a range of between 0° and 30° in a projection onto a plane perpendicular to the tower. For example, the first and the second ropes are configured to be arranged or are arranged in a common circular sector with a central angle in a range of between 0° and 45° in a projection onto a plane perpendicular to the tower. For example, the first and the second ropes are configured to be arranged or are arranged in a common circular sector with a central angle in a range of between 0° and 15° in a projection onto a plane perpendicular to the tower.

According to some embodiments, the first frame and the second frame are configured to be arranged next to each other and almost equidistant or equidistant from the tower. According to some embodiments, almost equidistant means that normal tolerances that occur in structures such as wind turbine towers are also included. For example, tolerances in a range of between 1% and 10% are included in the term almost equidistant.

For example, a first radial distance between the tower and the first frame is the same as a second radial distance between the tower and the second frame. For example, the first radial distance and the second radial distance differ by a maximum of 10%.

A distance between the first frame and the second frame along a circular arc around the tower for example is 6 meter or less. For example, the distance is 5 meters or less. For example, the distance is 4 meters or less. For example, the distance is 3 meters or less. For example, the distance is 2 meters or less. For example, the distance is 1 meter or less. For example, the distance is 0.5 meter or more. For example, the distance is in a range of between 1 and 6 meters.

According to some embodiments, the first frame and the second frame are configured to be arranged or are arranged concentrically to the tower. For example, the first frame and the second frame are configured to be arranged radially one behind the other. For example, a first radial distance between the tower and the first frame differs from a second radial distance between the tower and the second frame, in particular by more than the length of one frame. For example, the first radial distance differs from the second radial distance by more than 15%, for example more than 20%, for example more than 30%.

According to some embodiments, a first angle between the first rope and the tower is within a range of between 3° and 25°.

According to some embodiments, a second angle between the second rope and the tower is within a range of between 3° and 25°.

According to some embodiments, the first angle and/or the second angle is/are in a range of between 3° and 40°. According to some embodiments, the first angle and/or the second angle is/are in a range of between 3° and 35°. According to some embodiments, the first angle and/or the second angle is/are in a range of between 15° and 35°.

The frames are configured such that the angles between 3° and 25° may be realized. The frames are configured to be arranged or are arranged in a distance to the tower, such that the angles between the first and/or the second ropes are within a range of between 3° and 25°.

The first angle and the second angle may be the same or may differ from each other.

According to some embodiments, the first frame is configured to be coupled to a further rope and to keep the further rope under tension.

According to some embodiments, the second frame is configured to be coupled to a further rope and to keep the further rope under tension.

The frames each may be configured to be coupled to more than one rope.

It is possible that each rope is connected to its own associated frame. In this example there are as many ropes as frames, e.g. one rope per frame.

According to another example two or more ropes of one direction are connected to a common frame. In this example there are more ropes than frames. For example, all ropes of one direction are connected to one single frame of this direction.

According to some embodiments, the damping system comprises a first damping device as disclosed herein, and a second damping device as disclosed herein. The first and the second damping devices are arrangeable or are arranged such that they enclose an angle of less than 180° in a projection onto a plane perpendicular to the tower. According to some embodiments, the first and the second damping devices are arrangeable or are arranged such that they enclose an angle of 180° in a projection onto a plane perpendicular to the tower.

For example, the first and the second damping devices are arrangeable or are arranged such that they enclose an angle of more than 45° in a projection onto a plane perpendicular to the tower. For example, the first and the second damping devices are arrangeable or are arranged such that they enclose an angle in a range of between 60° and 120° in a projection onto a plane perpendicular to the tower. For example, the first and the second damping devices are arrangeable or are arranged such that they enclose an angle in a range of between 65° and 115° in a projection onto a plane perpendicular to the tower. For example, the first and the second damping devices are arrangeable or are arranged such that they enclose an angle of 90°+/−20° in a projection onto a plane perpendicular to the tower.

The first and the second damping devices are arranged mutually distinctive directions. The first and the second damping devices are arranged in mutually distinctive circular sectors.

For example, in the first circular sector, the first frame and the second frame are arranged. In the second circular sector, which is different from the first circular sector, the third and the fourth frame are arranged. For example, the first and the second circular sector are arranged such that they enclose an angle of 90°+/−20° in a projection onto a plane perpendicular to the tower. For example, in each circular sector a pair of frames is arranged. For example, in each circular sector one single frame is arranged. For example, in each circular sector three frames are arranged.

The tower system comprises a tower for the wind turbine. The tower is built on a ground. The tower system comprises a damping device as disclosed herein. The tower system may comprise a plurality of damping devices as disclosed herein. For example, a damping system is provided and coupled to the tower.

The first rope is connected to the tower and the first frame is anchored to the ground, such that the first rope is tensioned between the rope and the first frame. For example, the first rope is connected to an upper-mid section of the tower and/or a top tower section. Additional frames may be anchored to the ground corresponding to the first frame. Additional ropes may be tensioned by their associated frame corresponding to the first rope.

According to some embodiments, the tower system comprises the first, the second, a third and a fourth rope, as well as the first, the second, a third and a fourth frame. The first, the second, a third and a fourth frames are arranged along a common circle with the tower as its center, wherein a distance between the second and third frames is at least twice as large as the distance between the first and second frames and the distance between the third and fourth frames. The first, the second, a third and a fourth frames are arranged surrounding the tower, wherein the distance between the second and third frames is at least twice as large as the distance between the first and second frames and the distance between the third and fourth frames. For example, the first and the second frame are arranged in one common circular sector. For example, the third and the fourth frame are arranged in another common circular sector.

According to some embodiments, the tower system comprises the first, the second, a third and a fourth rope, as well as the first, the second, a third and a fourth frame. The first frame is radially arranged between the tower and the second frame and wherein the third frame is radially arranged between the tower and the fourth frame. For example, the first and the second frame are arranged in one common circular sector. For example, the third and the fourth frame are arranged in another common circular sector.

According to some embodiments, each of the frames is arranged at a distance from the tower of 24 meters or less.

According to some embodiments, each of the ropes comprise an angle to the tower of within a range of between 3° and 25°.

The method comprises:
providing an information on a site condition where the wind turbine is to be built,
determining, based on the information, at least one of the following configuration variables:
a circular sector for the first rope of the damping device,
a number of ropes for per common circular section, and
a distance between the first frame and the tower.

Bases on the information on the site conditions, the damping device is adjusted. For example, a damping system as disclosed herein is to be installed. The damping system is adjusted based on the information on the site conditions. For example, the information on the site condition comprises at least one information about: a wind strength, a wind direction, a ground conditions, and an available construction space at the site.

For example, for a site with stronger winds to be expected more ropes per common direction will be provided than for another site where lighter winds are expected.

For example, if the site allows for a smaller radial distance between the frame and the tower, more ropes are provided than if a larger radial distance is possible.

According to some embodiments, the method comprises:
providing a tower related configuration parameter,
determining the configuration variable or the configuration variables dependent on the tower related configuration parameter.

For example, the number of ropes and/or the location of the frames with respect to the tower is determined based on the tower related configuration parameter. For example, the tower related configuration parameter comprises at least one information about: an intended height of the tower, an intended material of the tower, an outer diameter of the tower, for example at a height of 18 meters or more, a mass of the tower, a natural frequency of the tower, and locations of fastening points for the ropes at the tower.

According to some embodiments, the method comprises:
providing a wind turbine related configuration parameter,
determining the configuration variable or the configuration variables dependent on the wind turbine related configuration parameter. For example, the wind turbine related configuration parameter comprises at least one information about: a mass of the wind turbine, a mass of the nacelle, a type of the nacelle, a mass of the rotor, a type of the rotor, a mass of the rotor blades, and a type of the rotor blades.

For example, the number of ropes and/or the location of the frames with respect to the tower is determined based on the wind turbine related configuration parameter.

Advantages and features damping device, the damping system, the tower system and/or the method may also apply to the other embodiments.

### BRIEF DESCRIPTION OF THE DRAWINGS

Embodiments of the present invention will be further described with reference to the accompanying drawings. In the drawings, elements of the same structure and/or functionality may be referred to by the same reference signs. Embodiments shown in the figures are illustrative representations and are not necessarily drawn to scale.

FIG. 1 is a schematic view of a wind turbine according to an embodiment.

FIG. 2 is a schematic view of a tower system according to an embodiment.

FIG. 3 is a schematic view of a tower system according to an embodiment.

FIG. 4 is a schematic view of a tower system according to an embodiment.

FIG. 5 is a schematic view of a tower system according to an embodiment.

FIG. 6 is a schematic view of a tower system according to an embodiment.

FIG. 7 is a schematic view of a tower system according to an embodiment.

FIG. 8 is a schematic view of a tower system according to an embodiment.

FIG. 9 is a schematic view of a tower system according to an embodiment.

FIG. 10 is a flowchart of a method according to an embodiment.

### DETAILED DESCRIPTION OF ILLUSTRATIVE EMBODIMENTS

While the invention is amenable to various modifications and alternative forms, specifics thereof have been shown by way of examples in the drawings and will be described in detail. It should be understood, however, that the intention is not to limit the invention to the particular embodiments described. On the contrary, the intention is to cover all modifications, equivalents and alternatives falling within the scope of the invention as defined by the appended claims.

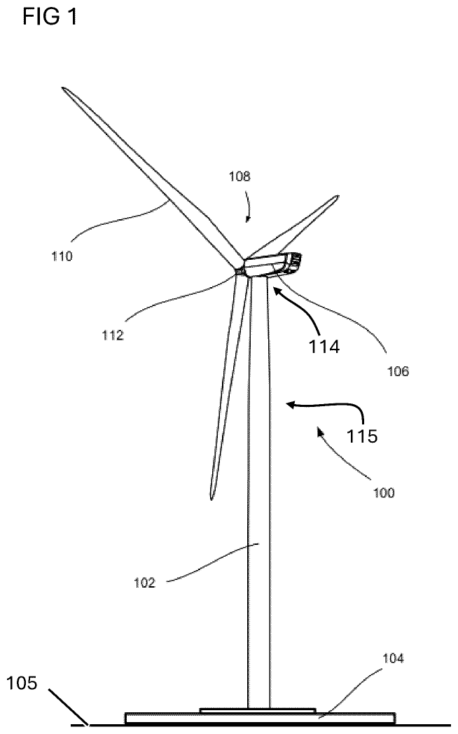

As shown in FIG. 1, a wind turbine 100 comprises a tower 102. The tower 102 is connected to a foundation 104 fixed to a ground 105. Specifically, the foundation 104 may be formed at a predetermined depth inside the ground 105, which is reinforced by a composite structure, for example a concrete support. A nacelle 106 is arranged on a top of the tower 102 opposite the foundation 104. The nacelle 106 carries a rotor 108 that houses the drive train among other components and subassemblies. Inside the nacelle 106, for example, a generator is arranged that is connected to the rotor 108 via the drive train. The drive train may comprise, for example, a gearbox and a rotor shaft. The rotor 108 comprises several rotor blades 110. The rotor blades are mounted on a rotor hub 112. The rotor hub 112 is connected to the rotor shaft (not explicitly shown).

For example, the rotor 108 is driven by an airflow interaction of moving wind with the rotor blades 110 of the rotor 108. The rotational movement of the rotor 108 is transmitted via the drive train to the generator. The generator converts the mechanical output of the rotor 108 into electrical energy.

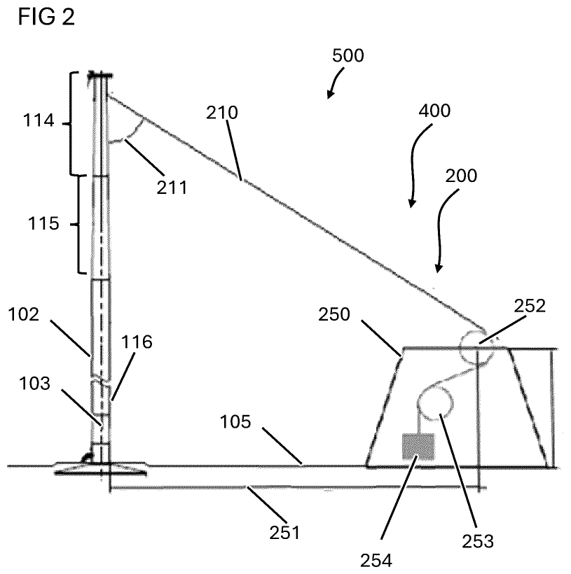

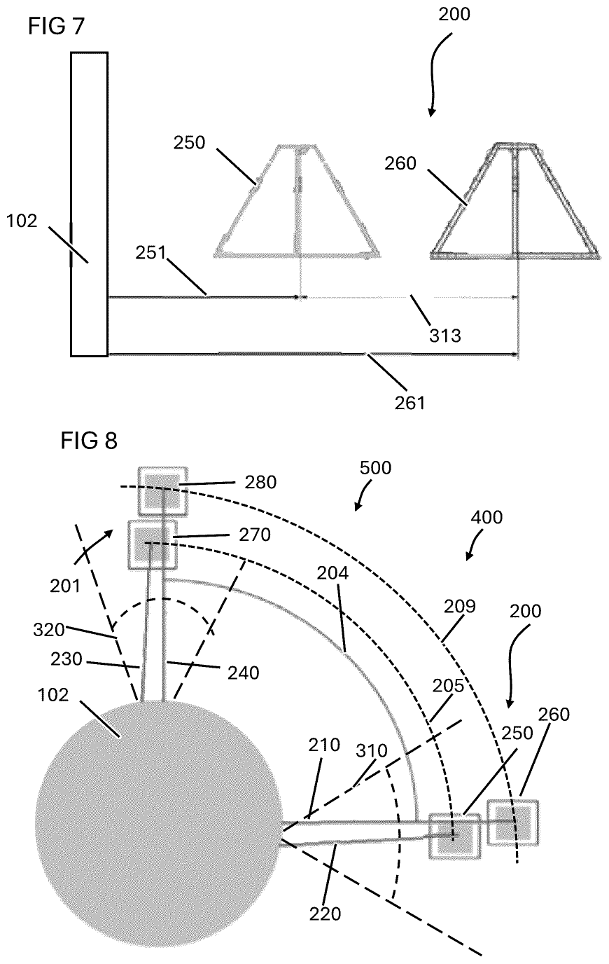

For example, during the assembling and erection of the wind turbine 100, for example before the nacelle 106 is attached to the top of the tower 102 or before the rotor 108 is mounted on the main shaft, transverse oscillations may occur at the tower 102 due to air currents. In order to damp such vortex-excited transverse oscillations, a damping system 400 as shown in FIGS. 2 to 9 may be used. The damping system 400 is then removed in particular after the assembling of the wind turbine 100 has been completed, for example after the nacelle 106 has been arranged at the top of the tower 102 and after the rotor 108 has been mounted.

FIG. 2 schematically shows a basic operating principle of the damping system 400 at the tower 102. The tower 102 and the damping system 400 are part of a tower system 500.

The damping system 400 comprises a damping device 200. In particular, the damping system 400 comprises two or more damping devices 200, 201. For example, each of the damping devices 200, 201 has the same structure and features the same components. Therefore, the description of damping device 200 may also apply to the damping device 201 and vice versa.

The damping device 200 can also be referred to as a Frictional Guy Rope (FGR). The damping device 200 allows the tower 102 not entering resonance due to Vortex effect covering any wind direction, in particular during erection of the wind turbine 100.

The damping device 200 comprises a rope 210. The damping device 200 comprises a frame 250.

The rope 210 for example comprises a wire rope, in particular a spiral cable.

A first end of the rope 210 is attached to the tower 102. The rope 210 is attached to a top tower section 114 which is directly adjacent to the top of the tower 102. Alternatively, the rope may be attached to an upper-mid tower section 115 which is located in the upper half of the tower 102 along a central tower axis 103 and adjoins the middle section. The tower 102 extends lengthwise along central tower axis 103.

To maintain tension in rope 210, a second end (lower end) of the rope 210 is suspended by a ballast mass 254 located inside the frame 250. The rope 210 is in stretch contact with a first, upper beam 252 and a second, lower beam 253 producing friction and displacement of the rope 210. The beams 252, 253, for example, are made of wood. Other materials for the beams 252, 253 are possible. The first beam 252 is further away from the ground 105 along the vertical than the second beam 253.

For example, the rope 210 is guided successively over the first and the second beams 252, 253, wherein the beams 252, 253 for example each at least partially have a convex surface made of a material which, in conjunction with a round-strand steel rope 210 in the dry state, results in a sliding friction coefficient of greater than 0.3, for example greater than 0.4.

The frame 250 is anchored to the ground 105. The frame 250 is supported in a stationary manner on the ground 105. In particular, the frame 250 is fixed to ground such that is immovable with respect to the tower 102 for the forces occurring during intended operation of the damping device 200.

The frame is attached to the ground 105 in a distance 251. The distance 251 for example is determined dependent on at least one of properties of the tower, for example a height of the tower and/or a material of the tower, and properties of the site, where the wind turbine 100 is being built, for example available space around the tower and/or expected winds. Other influencing variables may be considered for determining the distance 251.

For example, the distance 251 is the distance between the axis of the first beam 252 and a tower shell 116. Alternatively, the distance 251 may be the distance between the axis of the first beam 252 and the central tower axis 103. Alternatively, the distance 251 may be the distance between the center of the frame 250 and tower shell 116. Alternatively, the distance 251 may be the distance between the center of the frame 250 and the central tower axis 103.

The rope 210 is attached to the tower 102 such that the rope 210 and the tower 102 enclose an angle 211. The angle 211 is dependent on the location of the attachment of the rope 210 at the tower 102, in particular at what height the rope 210 is connected to the tower 102. The angle 211 is dependent on the distance 251. For example, the angle 211 is in a range of between 3° and 25°.

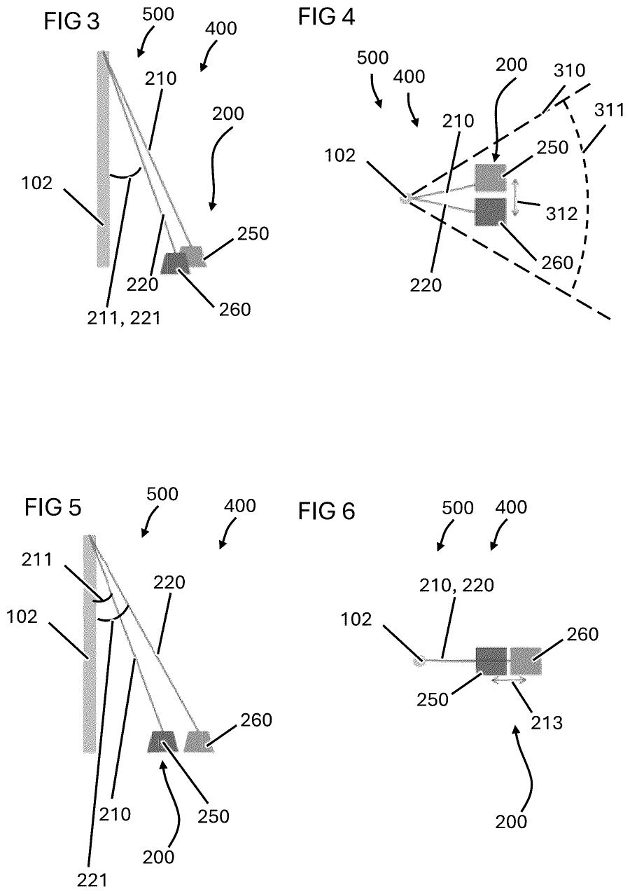

FIGS. 3 to 9 show examples where more than one rope 210 is provided per one common direction. Thus, one damping device 200 comprises for example two ropes 210, 220.

For example, one damping device 200 comprises three or more ropes 210, 220 (not explicitly shown). One damping device 200 comprises for example two frames 250, 260. For example, one damping device 200 comprises three or more frames 250, 260 (not explicitly shown).

It is possible that each rope 210, 220 is connected to its own associated frame 250, 260. In this example there are as many ropes 210, 220 as frames 250, 260 (one rope per frame).

According to another example (not explicitly shown) two or more ropes 210, 220 of one direction are connected to one common frame 250. In this example one damping device 200 comprises more ropes 210, 220 than frames 250. For example, all ropes 210, 220 of one damping device 200 are connected to one single frame 250.

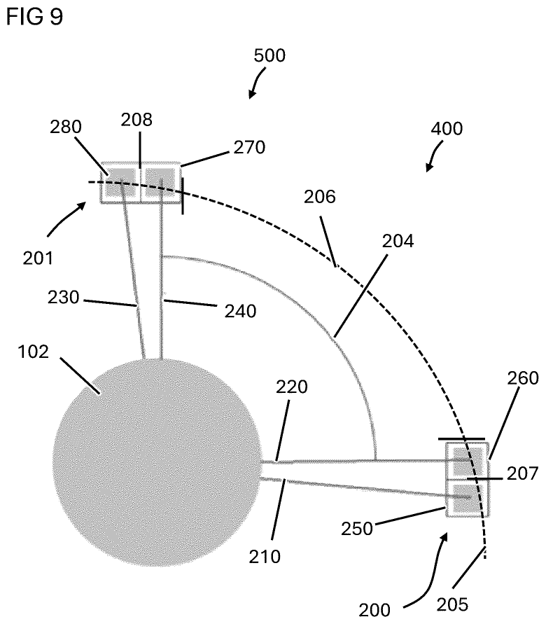

FIGS. 3 and 4 show a so-called parallel configuration of the damping device 200 with two ropes 210, 220 and two frames 250, 260. The damping device 200 is provided to secure the tower 102 along a common direction. In order to tension the tower in several distinctive directions, several damping devices 200, 201 must be provided, as also explained below in connection with FIG. 9.

The second rope 220 is attached to the tower 102 such that the second rope 220 and the tower 102 enclose a second angle 221. The angle 221 is dependent on the location of the attachment of the second rope 220 at the tower 102, in particular at what height the second rope 220 is connected to the tower 102. The angle 221 is also dependent on the distance 251 between the second frame 260 and the tower 102. For example, the second angle 221 is in a range of between 3° and 25°.

FIG. 3 shows a perspective-distorted representation in terms of the distance 251 and the angles 211, 221. In particular, the first angle 211 between the first rope 210 and the tower 102 and the second angle 221 are equal in size. In particular, the first frame 250 and the second frame 260 are arranged radially at the same distance 251 from the tower 102. For example, tolerances and deviations of up to 10% for the angles 211, 221 and the distances 251 are included.

For example, the distance 251 is 24 meters or less. For example, the distance 251 is in a range of between 5 and 24 meters. For example, the distance 251 is in a range of between 8 and 21 meters. For example, the distance 251 is in a range of between 11 and 18 meters. For example, the distance 251 is one of 10 meters, 11 meters, 12 meters, 13 meters, 14 meters, and 15 meters.

In particular, the first angle 211 depends on the distance 251. According to an example, the distance 251 is 13 meters and the first angle 211 is 10.1°.

The two ropes 210, 220 of the damping device 200 tension the tower 102 along a common direction. Therefore, the two ropes 210, 220 are arranged in a common circular sector 310. For example, the two frames are arranged in the common circular sector 310. The common circular sector is a circular sector with a central angle 311 of less than 45°, less than 30° or less than 10°.

For example, the angle between the two ropes is 2°. For example, the two frames 250, 260 comprise a first frame distance 312 between each other. For example, the first frame distance 312 is 4.5 meters. Of course, other values are possible, for example in a range of between 0.5 meters and 10 meters. In particular, the first frame distance 312 is measured between the centers of the adjacent frames 250, 260. Other values are possible, in particular in a range between 1° and 10° and between 1 meter and 10 meters. The two frames 250, 260 are arranged next to each other in the same radial direction and almost equidistant or equidistant from the tower 102.

FIGS. 5 to 7 show a so-called aligned configuration of the damping device 200 with two ropes 210, 220 and two frames 250, 260. The damping device 200 is provided to secure the tower 102 along a common direction. In order to tension the tower in several distinctive directions, several damping devices 200, 201 must be provided, as also explained below in connection with FIG. 8.

The damping device 200 comprises two ropes 210, 220 and two frames 250, 260 as the damping device 200 disclosed in connection with FIGS. 3 and 4. The two ropes 210, 220 and two frames 250, 260 are aligned differently with respect to each other.

According to the examples of FIGS. 5 to 7, the damping device 200 comprises two frames 250, 260 with two ropes 210, 220 (at least one rope per frame) per one common direction.

The two frames 250, 260 are arranged concentrically with respect to the tower 102. For example, the two frames 250, 260 are arranged radially one behind the other. The first frame 250 is arranged nearer to the tower 102 than the second frame 260. The first frame 250 is arranged between the tower 102 and the second frame 260 along a direction radial to the tower axis 103. The second frame 260 is arranged further away from the tower 102 than the first frame 250.

The second frame is arranged at a second distance 261 from the tower 102. Comparable to the first distance 251, for example, the second distance 261 is the distance between the axis of a first beam (not explicitly shown) of the second frame 260 and the tower shell 116. Alternatively, the second distance 261 may be the distance between the axis of the first beam of the second frame 260 and the central tower axis 103. Alternatively, the second distance 261 may be the distance between the center of the second frame 260 and tower shell 116. Alternatively, the second distance 261 may be the distance between the center of the second frame 260 and the central tower axis 103.

For example, the first distance 251 and the second distance 261 vary from each other such that the first frame 250 and the second frame 260 are arranged with a second frame distance 313 between each other. In particular, the second frame distance 313 is measured between the centers of the adjacent frames 250, 260. For example, the second frame distance 313 is perpendicular to the first frame distance 312 shown in FIG. 4. The second frame distance 313 extends radially from the tower 102. For example, the second frame distance 313 is in a range of 3.5 meters to 10 meters. For example, the second frame distance 313 is in a range of 4 meters to 10 meters. For example, the second frame distance 313 is in a range of 4 meters to 6 meters. For example, the second frame distance 313 is 4.5 meters. Other values are possible.

For example, the second distance 261 between the second frame 260 and the tower 102 is 24 meters or less. For example, the second distance 261 is in a range of between 5 and 24 meters. For example, the second distance 261 is in a range of between 8 and 21 meters. For example, the second distance 261 is in a range of between 11 and 18 meters. For example, the second distance 261 is one of 10 meters, 11 meters, 12 meters, 13 meters, 14 meters, and 15 meters.

In a projection onto a plane parallel to the ground 104, the two ropes 210, 220 are congruent, as shown in FIG. 6. The second rope 220 runs above the first rope 210. In particular, the first angle 211 between the first rope 210 and the tower 102 and the second angle 221 are different in size. The second angle 221 is larger than the first angle 211.

FIGS. 8 and 9 each show a damping system with two damping devices 200, 201. FIG. 8 show the two damping devices 200, 201 with the aligned configuration as disclosed with respect to FIGS. 5 to 7. FIG. 9 show the two damping devices 200, 201 with the parallel configuration as disclosed with respect to FIGS. 3 and 4. It is also possible that one damping device 200 is in the aligned configuration and the other damping device 201 is in the parallel configuration. It is possible that more than two damping devices 200, 201 are arranged, for example three damping, four damping devices or more.

The two damping devices 200, 201 shown in FIGS. 8 and 9 are arranged in two different directions with respect to each other. The second damping device 201 is arranged in a second circular sector 320. The two damping devices 200, 201 are arranged in distinctive circular sectors 310, 320. In particular, the first and second circular sectors 310, 320 are arranged differently from each other and do not overlap.

The second damping device 201 is configured in the same way as the first damping device 200. The second damping device 201 comprises third frame 270 and a fourth frame 280. The third frame 270 is comparable to the first frame 250. The fourth frame 280 is comparable to the first frame 250. The third frame 270 and the fourth frame 280 are arranged in the second circular sector 320.

The second damping device 201 comprises third rope 230 and a fourth rope 240. The third rope 230 is comparable to the first rope 210. The fourth rope 240 is comparable to the second rope 240. The third rope 230 and the fourth rope 240 are arranged in the second circular sector 320.

The first damping device 200 and the second damping device 201 are arranged at a distance to each other. The first damping device 200 and the second damping device 201 are arranged such they enclose an angle 204. For example, the angle 204 is measured between the two ropes 210, 240 of the two damping devices 200, 201 that are closest to each other.

For example, the angle 204 is of less than 180°, for example less than 120°, for example approximately 60° to 120°, for example 90°+/−20°.

For example, a total of four ropes 210, 220, 230, 240 with corresponding four frames 250, 260, 270, 280 is arranged, whereby two ropes 210, 220; 230, 240 and the corresponding frames 250, 260; 270, 280 are arranged in parallel in each direction. For example, two ropes 210, 220; 230, 240 with corresponding frames 250, 260; 270, 280 are arranged in each of the two orthogonal directions and in the two distinctive circular sectors 310, 320. Thus, four ropes 210, 220, 230, 240 with corresponding frames are arranged in total per tower 250, 260, 270, 280.

In FIG. 8, for example, the first frame 250 and the third frame 270 are arranged on a common circle 205 with the tower 102 as its center. The second frame 260 and the fourth frame 280 are arranged on a further common circle 209 with the tower 102 as its center. The further common circle 209 comprises a larger radius than the common circle 205.

In FIG. 9, for example, all four frames 250, 260, 270, 280 are arranged on one common circle 205. A distance 206 along the common circle 205 between the second frame 260 and the third frame 270 is many times larger than a distance 207 between the first frame 250 and the second frame 260. The distance 206 between the second frame 260 and the third frame 270 is many times larger than a distance 208 between the third frame 270 and the fourth frame 280.

More than two ropes per direction are possible. More or less than two frames per direction are possible.

Both in the parallel configuration and in the aligned configuration, it is possible that less frames than ropes are arranged. For example, the two ropes of each direction are coupled to one respective frame. For example, one single frame is arranged per direction and all ropes of a specific direction are connected to the one single frame of this specific direction. It is also possible that in one direction each frame is connected to one single rope only and in another direction a frame is connected to two or more ropes.

The damping device 200, 201 for damping tower vibrations comprises more than two ropes, for example three ropes, four ropes, or more than four ropes, all comprised within a common circular sector 310, 320 of less than 360° around the tower, for example less than 180°, less than 120°, or in a circular sector 310, 320 of 90°+/−20°.

For example, the allowed circular sector 310, 320 for at least two ropes, particular for the specific damping devices 200, 201 is determined based on at least one parameter dependent on the site conditions (orography and/or other land constraints imposed for example by environmental restrictions).

For example, at least a safety parameter regarding the use of the damping system 400 is determined based on the geometrical design of the damping system 400. Wherein the at least one safety parameter for example includes at least a first value for a maximum allowable time frame for the subassembly (unfinished wind turbine 100) to stay with the determined damping configuration in at least one predetermined construction stage.

For example, a method of determining a site-specific configuration for the device for dampening tower vibrations comprises the following steps:
providing at least one geometrical site-dependent configuration parameter dependent on the site conditions (orography and/or other land constraints imposed for example by environmental restrictions)
determining at least one of the following configuration variables:
an allowed circular sector for at least two ropes for a damping system and/or
a number of ropes and/or
at least one distance for the connection of the ropes to respective frames in the ground
wherein the value of each of the configuration variables is determined based on the at least one geometrical site-dependent configuration parameter.

Wherein the circular sector is for example smaller than 180°, for example even smaller than 120°.

For example, the method further comprises the following steps:
providing at least one wind turbine related configuration parameter and/or a tower-related configuration parameter and
determining at least a safety parameter regarding the use of the damping system based on at least one value of each of the configuration variables of the device for dampening tower vibrations.

For example, at least a safety parameter regarding the use of the damping system is determined based on the geometrical design of the damping system. Wherein the at least one safety parameter for example includes at least a first value for a maximum allowable time frame for the subassembly to stay with the determined damping configuration in at least one predetermined construction stage.

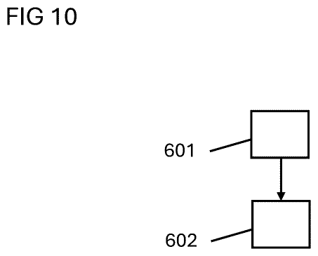

FIG. 10 shows a flow chart of a method for determining a site-specific configuration for the damping device 200, 201 for the tower 102 of the wind turbine 100. For example, a configuration for the damping system 400 may be determined with the method.

In a step 601, an information on a site condition where the wind turbine 100 is to be built is provided. For example, a plurality of information is determined. Optionally, a tower related configuration parameter is provided. Optionally, a wind turbine related configuration parameter is provided.

In a step 602, at least one of the following configuration variables is determined based on the provided information:
the circular sector 310 for the first rope 210 of the damping device 200,
a number of ropes 210, 220, 230, 240 for per common direction, and
the distance 251 between the first frame 250 and the tower 102.

Additional configuration parameters for additional damping devices 201 may be determined, for example, respective circular sectors 310, 320 for the other ropes 220, 230, 240, and/or respective distances 251, 261 for the other frames 260, 270, 280.

For example, the configuration parameters are additionally determined dependent on the provided the tower related configuration parameter.

For example, the configuration parameters are additionally determined dependent on the wind turbine related configuration parameter.

Applicant has surprisingly discovered that the damping device 200, 201 and the damping system 400 with a plurality of ropes 210, 220, 230, 240 per common direction enables a reliable damping and prevention of vibrations. For example, this makes the distances 251, 261 of less than 24 meters possible.

1. A damping device comprising:
a first rope configured to be connected to a tower; and
a first frame configured to be supported in a stationary manner on ground, to be coupled to the first rope, and to keep the first rope under tension.

2. The damping device according to claim 1, further comprising:
a second rope configured to be connected to the tower; and
a second frame configured to be supported in a stationary manner on the ground, to be coupled to the second rope and to keep the second rope under tension,
wherein the first and the second ropes are configured to be arranged in a common circular sector with a central angle in a range of between 0° and 30° in a projection onto a plane perpendicular to the tower.

3. The damping device according claim 2, wherein the first frame and the second frame are configured to be arranged next to each other and equidistant or equidistant from the tower.

4. The damping device according to claim 2, wherein the first frame and the second frame are configured to be arranged concentrically to the tower.

5. The damping device according to claim 4, where the first frame and the second frame are configured to be arranged radially one behind the other.

6. The damping device according to claim 1, wherein a distance from the tower to the first frame is 24 meters or less.

7. The damping device according to claim 6, wherein the distance is in a range of between 8 and 21 meters.

8. The damping device according to claim 1, wherein an angle between the first rope and the tower is within a range of between 3° and 40°.

9. The damping device according to claim 1, wherein the first frame is configured to be coupled to a further rope and to keep the further rope under tension.

10. A damping system comprising:
first damping device comprising:
a first rope configured to be connected to a tower; and
a first frame configured to be supported in a stationary manner on ground, to be coupled to the first rope, and to keep the first rope under tension; and
a second damping device comprising:
a second rope configured to be connected to the tower; and
a second frame configured to be supported in a stationary manner on the ground, to be coupled to the second rope, and to keep the second rope under tension,
wherein the first and second damping devices are arrangeable such that the first and second damping devices enclose an angle of 180° or less in a projection onto a plane perpendicular to the tower.

11. The damping system according to claim 10, wherein the angle is in a range of between 60° and 120°.

12. A tower system for a wind turbine, the tower system comprising:
the tower for the wind turbine, the tower standing on the ground; and
the damping device according to claim 1,
wherein the first rope is connected to the tower and the first frame is supported in a stationary manner on the ground such that the first rope is tensioned between the tower and the first frame.

13. The tower system according to claim 12, wherein the first rope is connected to an upper-mid section of the tower and/or a top tower section.

14. The tower system according to claim 12, further comprising:
a second rope, a third rope and a fourth rope;
a second frame, a third frame and a fourth frame,
wherein the first, the second, the third and the fourth frames are arranged along a common circle with the tower as a center of the circle,
wherein a distance between the second and third frames is at least twice as large as a distance between the first and second frames, and a distance between the third and fourth frames.

15. The tower system according to claim 12, further comprising:
a second rope, a third rope and a fourth rope;
a second frame, a third frame and a fourth frame,
wherein the first frame is radially arranged between the tower and the second frame, and
wherein the third frame is radially arranged between the tower and the fourth frame.

16. The tower system according to claim 12, wherein each frames is arranged at a respective distance from the tower of 24 meters or less.

17. The tower system according to claim 12, wherein each ropes comprises a respective angle to the tower of within a range of between 3° and 40°.

18. A method for determining a site-specific configuration for the damping device for the tower of a wind turbine according to claim 1, the method comprising:
providing information on a site condition where the wind turbine is to be built; and
determining, based on the information, at least one of the following configuration variables:
a circular sector for the first rope of the damping device;
a number of ropes for per a common direction; and
a distance between the first frame and the tower.

19. The method according to claim 18, further comprising:
providing a tower related configuration parameter; and
determining the configuration variable(s) dependent on the tower related configuration parameter.

20. The method according to claim 18, further comprising:
providing a wind turbine related configuration parameter; and
determining the configuration variable(s) dependent on the wind turbine related configuration parameter.
